(19) United States
(12) Patent Application Publication
(10) Pub. No.: US 2018/0300111 A1
(43) Pub. Date: Oct. 18, 2018

(54) PRESERVING DYNAMIC TRACE PURITY

(71) Applicant: International Business Machines Corporation, Armonk, NY (US)

(72) Inventors: Kavana N. Bhat, Bangalore (IN); Savitri Hunasheekatti, Bangalore (IN); Nitin Kumar, Bangalore (IN)

(21) Appl. No.: 15/903,590

(22) Filed: Feb. 23, 2018

Related U.S. Application Data
(63) Continuation of application No. 15/488,684, filed on Apr. 17, 2017.

(51) Int. Cl. G06F 8/41; G06F 11/36

(52) U.S. Cl. CPC G06F 8/41; G06F 11/3636

(57) ABSTRACT

The present invention provides a computer implemented method, system, and computer program product of preserving dynamic trace purity. In an embodiment, the present invention includes compiling a dynamic tracing computer software script, tracing an execution of a host computer software program executing on the host computer system, resulting in trace data, activating probe points in the executing of the compiled dynamic tracing computer software script at which the trace data can be collected, collecting the trace data from the probe points, storing the collected trace data in predefined computer storage buffers within the host computer system, collecting the stored trace data on a periodic basis, storing the periodically collected trace data in a common device computer storage buffer, sorting the stored periodically collected trace data, converting raw address data within the sorted trace data into trace display data, and displaying the trace display data on a computer display.

### BACKGROUND

The present disclosure relates to dynamic tracing of computer software, and more specifically, to preserving dynamic trace purity.

### SUMMARY

The present invention provides a computer implemented method, a system, and a computer program product of preserving dynamic trace purity. In an exemplary embodiment, the computer implemented method, the system, and the computer program product include (1) compiling, by a host computer system, a dynamic tracing computer software script into a computer software format, where the computer software format is understandable by a dynamic tracing virtual machine executing on the host computer system and understandable by a trace consumer accelerator computer system logically coupled to the host computer system, resulting in a compiled dynamic tracing computer script, (2) executing, by the dynamic tracing virtual machine, a set of logical operations, represented by the compiled dynamic tracing computer software script, tracing an execution of a host computer software program executing on the host computer system, resulting in trace data, (3) activating, by the host computer system, points in the executing of the compiled dynamic tracing computer software script (probe points) at which the trace data can be collected, (4) collecting, by the host computer system, the trace data from the probe points, (5) storing, by the host computer system, the collected trace data in predefined computer storage buffers within the host computer system, where the predefined computer storage buffers are addressable by central processing units (CPUs) of the host computer system and are addressable by the trace consumer accelerator computer system, (6) collecting, by the trace consumer accelerator computer system, the stored trace data from the predefined computer storage buffers on a periodic basis, resulting in periodically collected trace data, (7) storing, by the trace consumer accelerator computer system, the periodically collected trace data in a common device computer storage buffer, (8) sorting, by the trace consumer accelerator computer system, the stored periodically collected trace data by the order of times at which the stored periodically collected trace data was generated by the executing of the compiled dynamic tracing computer software script, resulting in sorted trace data, (9) converting, by the trace consumer accelerator computer system, raw address data within the sorted trace data into trace display data, and (10) displaying, by the trace consumer accelerator computer system, the trace display data on a computer display.

### BRIEF DESCRIPTION OF THE DRAWINGS

FIG. 1A depicts a flowchart in accordance with an exemplary embodiment of the present invention.

FIG. 1B depicts a flowchart in accordance with an exemplary embodiment of the present invention.

FIG. 1C depicts a block diagram in accordance with an exemplary embodiment of the present invention.

FIG. 2A depicts a block diagram in accordance with an exemplary embodiment of the present invention.

FIG. 2B depicts a block diagram in accordance with an exemplary embodiment of the present invention.

FIG. 3 depicts a block diagram in accordance with an exemplary embodiment of the present invention.

FIG. 4 depicts a block diagram in accordance with an exemplary embodiment of the present invention.

FIG. 5 depicts a computer system in accordance with an exemplary embodiment of the present invention.

### DETAILED DESCRIPTION

The present invention provides a computer implemented method, a system, and a computer program product of preserving dynamic trace purity. In an exemplary embodiment, the computer implemented method, the system, and the computer program product include (1) compiling, by a host computer system, a dynamic tracing computer software script into a computer software format, where the computer software format is understandable by a dynamic tracing virtual machine executing on the host computer system and understandable by a trace consumer accelerator computer system logically coupled to the host computer system, resulting in a compiled dynamic tracing computer script, (2) executing, by the dynamic tracing virtual machine, a set of logical operations, represented by the compiled dynamic tracing computer software script, tracing an execution of a host computer software program executing on the host computer system, resulting in trace data, (3) activating, by the host computer system, points in the executing of the compiled dynamic tracing computer software script (probe points) at which the trace data can be collected, (4) collecting, by the host computer system, the trace data from the probe points, (5) storing, by the host computer system, the collected trace data in predefined computer storage buffers within the host computer system, where the predefined computer storage buffers are addressable by central processing units (CPUs) of the host computer system and are addressable by the trace consumer accelerator computer system, (6) collecting, by the trace consumer accelerator computer system, the stored trace data from the predefined computer storage buffers on a periodic basis, resulting in periodically collected trace data, (7) storing, by the trace consumer accelerator computer system, the periodically collected trace data in a common device computer storage buffer, (8) sorting, by the trace consumer accelerator computer system, the stored periodically collected trace data by the order of times at which the stored periodically collected trace data was generated by the executing of the compiled dynamic tracing computer software script, resulting in sorted trace data, (9) converting, by the trace consumer accelerator computer system, raw address data within the sorted trace data into trace display data, and (10) displaying, by the trace consumer accelerator computer system, the trace display data on a computer display. In a particular embodiment, the trace consumer accelerator computer system includes a coherent accelerator processor interface (CAPI) device. In a specific embodiment, the trace consumer accelerator computer system is a CAPI device. In a particular embodiment, the predefined computer storage buffers include portions of computer memory within the host computer system, where the portions have predefined computer memory addresses. In a specific embodiment, the predefined computer storage buffers are portions of computer memory within the host computer system, where the portions have predefined computer memory addresses.

### Definitions

Dynamic Tracing

Dynamic tracing is method of discovering information about system programs and user applications executing on a computer system. Dynamic tracing tools provide the facility to trace computer operating system (OS) internals. Via dynamic tracing, a user (e.g., a programmer) could obtain information about a computer system by tracing internal OS interfaces like thread dispatcher and task scheduler.

The typical steps followed in a dynamic tracing system are as follows: compilation of a user provided script to a format understood by a dynamic tracing virtual machine (e.g., a kernel-resident dynamic tracing virtual machine; processing of the script by the dynamic tracing virtual machine; generation of data by the dynamic tracing virtual machine; periodic copying of trace data in a buffer (e.g., kernel buffer) into user space application; and performing an analysis on the trace data per the user provided script and presenting the formatted output. The last two steps require data generated by the dynamic tracing virtual machine to be copied into user space buffers for consumption by a probe initiator and upon which to perform trace data analysis.

Dynamic tracing is an advanced form of tracing. The feedback received from tracing a computer system can also be used by the same computers system (i.e., a system could be traced for an event and another event could be scheduled based on the outcome of the original event).

### Problems with Dynamic Tracing

The last two steps of dynamic tracing (periodic copying of the trace data and performing an analysis on the trace data) are resource heavy and thus introduce impurity in the original debugged environment. Since in order to copy data to user space buffers, a consumer application would request memory from the kernel and if such a memory request could not be fulfilled, the kernel would perform some page out operations. If a dynamic tracing script (e.g., ProbeVue) were monitoring PAGEIN/PAGEOUT statistics, the result obtained would be impure since the dynamic probing system itself would contribute to a lot of paging activity, thereby rendering obtained results meaningless.

A trace consumer process also results in a lot of context switches, thereby resulting in a thread scheduler being initiated. A probe script monitoring system response accounting for thread scheduling data may be completely misled. It may be impossible to architect a dynamic tracing utility without polluting/introducing impurity to the original environment. Also, in dynamic tracing environments where conditional collection of trace data is not employed, the frequency of the generation of trace data could be high, which could result in trace buffer overflows if the trace consumer process were not run with higher priority and sufficient computing resources.

During the time operating system tracing tools collect trace data, the workload/application behavior changes a little bit as it involves copying/processing large amount of trace data, thereby introducing some impurity in the trace data itself as the logic that performs the data movement/processing runs on the same CPUs as the workload. Sometimes, this makes debugging difficult or even to the extent that problem may not occur itself.

A dynamic tracing framework may receive an output which is a function of the current state of the system. In the absence of knowledge of the current system run-time, a dynamic trace scenario is not feasible. Trace impurity is a problem in dynamic tracing frameworks. Systems conducting ordinary tracing do not suffer from these phenomena as they do not need to have a trace analyzer providing continuous feedback running on the same system.

Coherent Accelerator Processor Interface (CAPI)

A coherent accelerator processor interface (CAPI) is a high-speed processor expansion bus standard, initially designed to be layered on top of PCI Express®, for directly connecting CPUs to external accelerators like graphics processing units (GPUs), application-specific integrated circuits (ASICs), field-programmable gate arrays (FPGAs), or fast storage. A CAPI offers low latency, high speed, direct memory access connectivity between devices of different instruction set architectures.

CAPI is implemented as a functional unit inside the CPU, called the Coherent Accelerator Processor Proxy (CAPP) with a corresponding unit on the accelerator called the Power Service Layer (PSL). The CAPP and PSL units acts like a cache directory so the attached device and the CPU can share the same coherent memory space, and the accelerator becomes an Accelerator Function Unit (AFU), a peer to other functional units integrated in the CPU.

Since the CPU and AFU share the same memory space, low latency and high speeds can be achieved since the CPU does not have to do memory translations and memory shuffling between the main memory of the CPU and memory spaces of the accelerator. An application can make use of the accelerator without specific device drivers as everything is enabled by a general CAPI kernel extension in the host operating system. The CPU and PSL can read and write directly to each other's memories and registers, as demanded by the application.

CAPI is layered on top of PCIe generation 3, using 16 PCIe lanes, and is an additional functionality for the PCIe slots on CAPI enabled systems. Usually there are designated CAPI enabled PCIe slots on such machines.

Traditional transactions between a PCIe device and a CPU can take around 20,000 operations, whereas a CAPI attached device would only use around 500 operations, thereby significantly reducing latency, and effectively increasing bandwidth due to decreased operations overhead. The total bandwidth of a CAPI port is determined by the underlaying PCIe 3.0×16 technology, peaking at ca 16 GB/s, bidirectional. A CAPI device has coherent access to traced system's memory bus and does not need to have separate recording and trace buffers.

Bitonic Sort

Bitonic mergesort/bitonic sort is a parallel algorithm for sorting. It is also used as a construction method for building a sorting network. The resulting sorting networks consist of O(n log²(n)) comparators and have a delay of O(log²(n)), where n is the number of items to be sorted. A sorted sequence is a monotonically non-decreasing (or non-increasing) sequence. A bitonic sequence is a sequence with x₀≤ . . . ≤xₖ≥ . . . ≥xₙ₋₁ for some k, 0≤k<n, or a circular shift of such a sequence.

Need for Dynamic Tracing for Debugging Computer Software Applications

Dynamic tracing ability for debugging application while it is live is a necessary capability for highly available applications. The ability to improve trace purity would improve tracing tools.

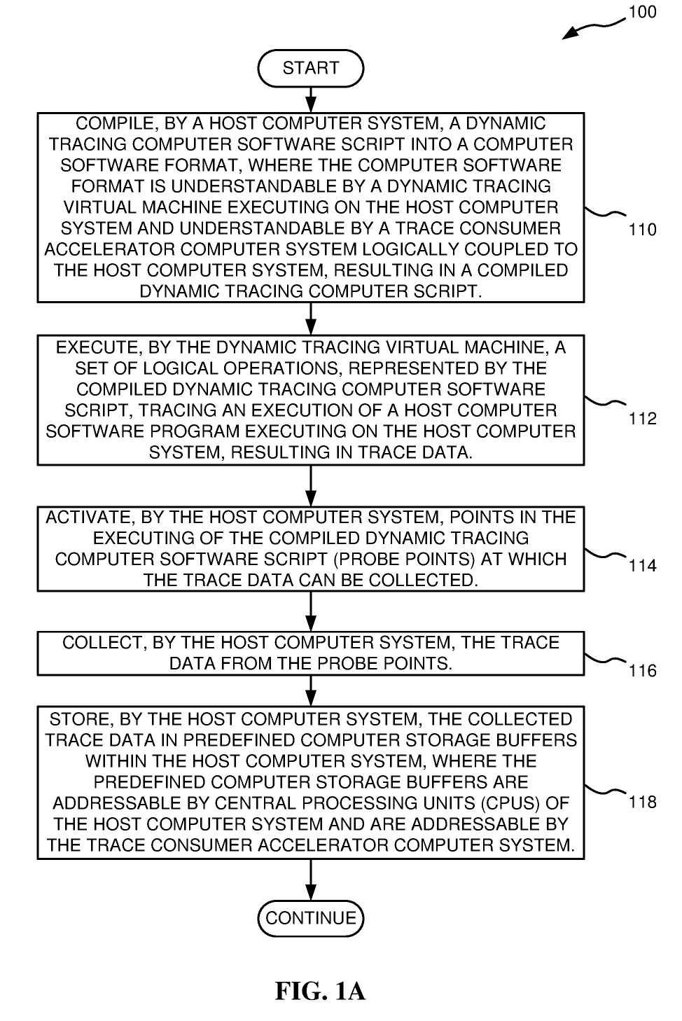

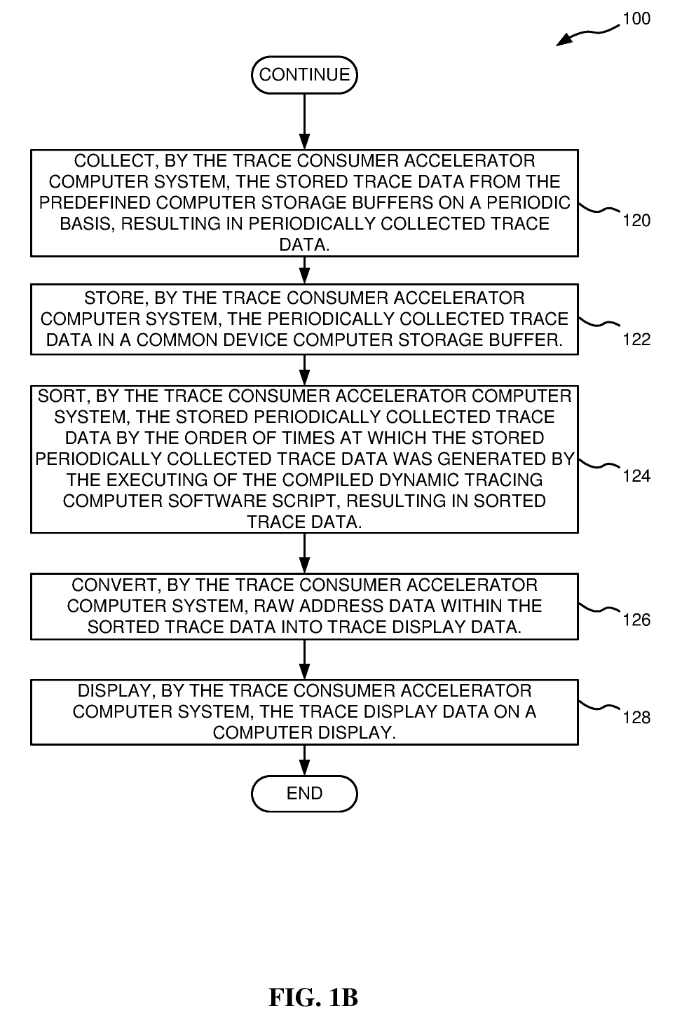

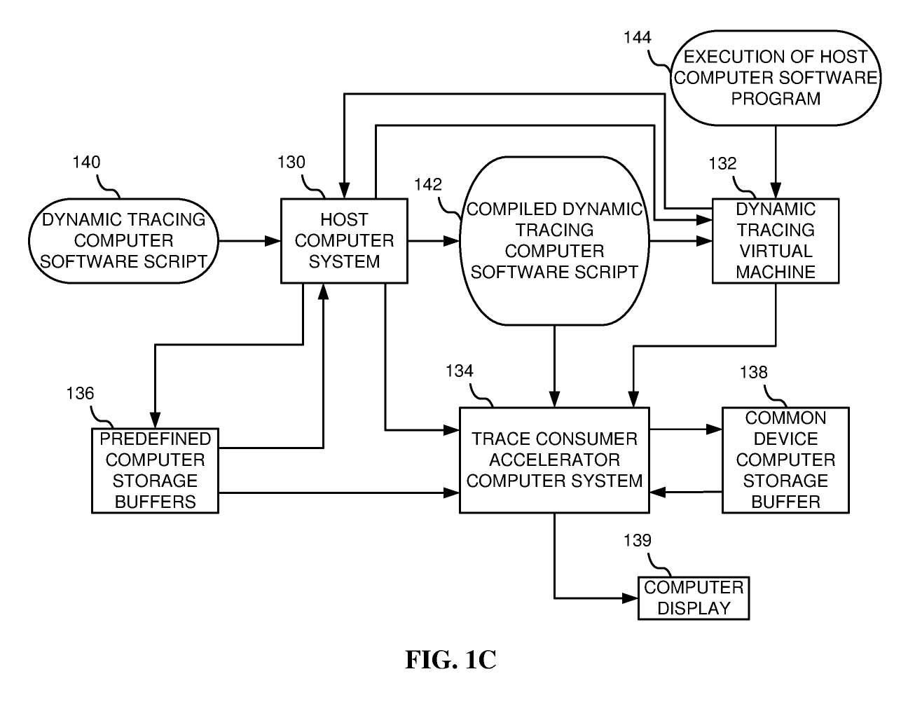

Referring to FIG. 1A and FIG. 1B, in an exemplary embodiment, the present invention is configured to perform an operation 110 of compiling, by a host computer system, a dynamic tracing computer software script into a computer software format, where the computer software format is understandable by a dynamic tracing virtual machine executing on the host computer system and understandable by a trace consumer accelerator computer system logically coupled to the host computer system, resulting in a compiled dynamic tracing computer script, an operation 112 of executing, by the dynamic tracing virtual machine, a set of logical operations, represented by the compiled dynamic tracing computer software script, tracing an execution of a host computer software program executing on the host computer system, resulting in trace data, an operation 114 of activating, by the host computer system, points in the executing of the compiled dynamic tracing computer software script (probe points) at which the trace data can be collected, an operation 116 of collecting, by the host computer system, the trace data from the probe points, an operation 118 of storing, by the host computer system, the collected trace data in predefined computer storage buffers within the host computer system, where the predefined computer storage buffers are addressable by central processing units (CPUs) of the host computer system and are addressable by the trace consumer accelerator computer system, an operation 120 of collecting, by the trace consumer accelerator computer system, the stored trace data from the predefined computer storage buffers on a periodic basis, resulting in periodically collected trace data, an operation 122 of storing, by the trace consumer accelerator computer system, the periodically collected trace data in a common device computer storage buffer, an operation 124 of sorting, by the trace consumer accelerator computer system, the stored periodically collected trace data by the order of times at which the stored periodically collected trace data was generated by the executing of the compiled dynamic tracing computer software script, resulting in sorted trace data, an operation 126 of converting, by the trace consumer accelerator computer system, raw address data within the sorted trace data into trace display data, and an operation 128 of displaying, by the trace consumer accelerator computer system, the trace display data on a computer display.

In an embodiment, the present invention offloads a trace buffer collection to an independent computing system having coherent access to a memory bus of a traced system, the host computer system, using multithreaded accelerators to improve the performance of trace data processing. For example, the present invention could use a CAPI device/accelerator device to collect trace generated by multiple CPUs of the host computer system at fixed/agreed address locations, to accelerate the processing of trace data, and to produce tracing results to a user. The present invention could ensure that the trace collected on the host computer system has minimum impact on the traced environment since no other process would be introduced which could introduce impurity to the tracing system. The present invention could improve trace data purity and dynamic trace performance by not disturbing resources of the host computer system for trace data movement and post processing. In an embodiment, the present invention uses a coherent memory accelerator (e.g., a CAPI device)/accelerator device to store trace data on separate memory than the memory of the host computer system and to run post processing logic. The present invention could minimize impact on the workload behavior of the host computer system while computer software executing on the host computer system is being traced.

In an embodiment, the present invention performs dynamic tracing, as the trace location is dynamic and can be changed in run time. In an embodiment, the present invention initiates collection of data in light of a traced system (host computer system) asynchronously and independently of the host computer system. In an embodiment, the present invention facilitates tracing with run-time system knowledge. The present invention could enable tracing of computer software applications executing on the host computer system as well as tracing the entire host computer system. The present invention could be deployed in complex environments that have multi-privileged execution environments, such as a computer system running a UNIX® operating system.

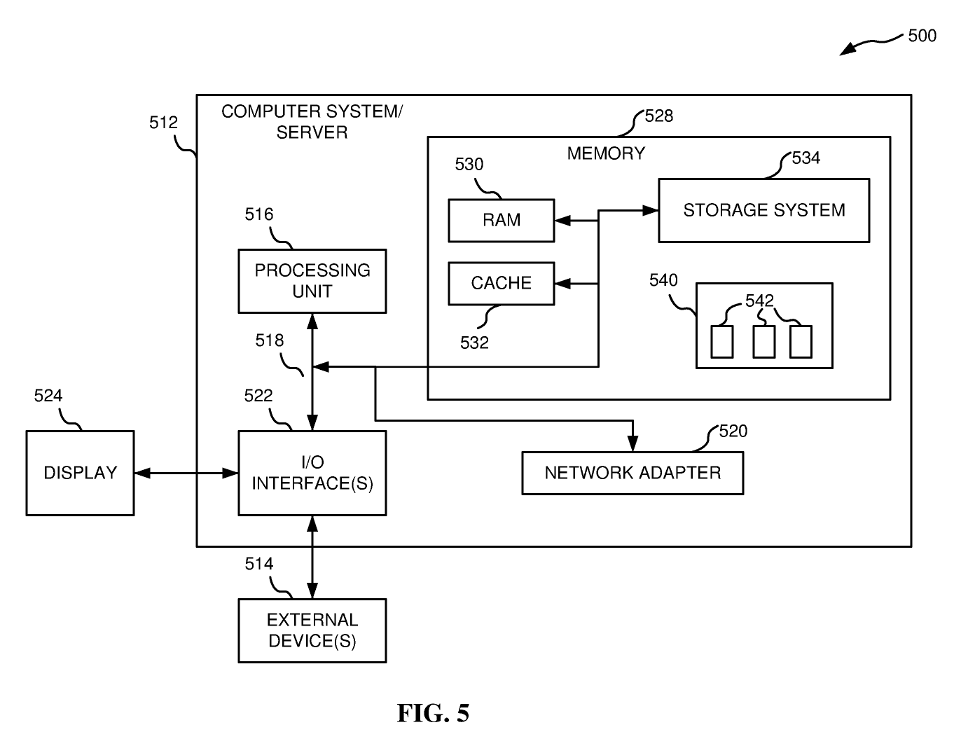

In an embodiment, the host computer system is a computer system 500 as shown in FIG. 5, that executes a preserving dynamic trace purity script or computer software application that carries out the operations of at least method 100. In an embodiment, the host computer system is a computer system/server 512 as shown in FIG. 5, that executes a preserving dynamic trace purity script or computer software application that carries out the operations of at least method 100. In an embodiment, the host computer system is a processing unit 516 as shown in FIG. 5, that executes a preserving dynamic trace purity script or computer software application that carries out the operations of at least method 100. In an embodiment, the host computer system is a computer system 500 as shown in FIG. 5, that executes a preserving dynamic trace purity script or computer software application that carries out at least operations 110, 114, 116 and 118. In an embodiment, the host computer system is a computer system/server 512 as shown in FIG. 5, that executes a preserving dynamic trace purity script or computer software application that carries out at least operations 110, 114, 116 and 118. In an embodiment, the host computer system is a processing unit 516 as shown in FIG. 5, that executes a preserving dynamic trace purity script or computer software application that carries out at least operations 110, 114, 116 and 118.

In an embodiment, the dynamic tracing virtual machine is a computer system 500 as shown in FIG. 5, that executes a preserving dynamic trace purity script or computer software application that carries out the operations of at least method 100. In an embodiment, the dynamic tracing virtual machine is a computer system/server 512 as shown in FIG. 5, that executes a preserving dynamic trace purity script or computer software application that carries out the operations of at least method 100. In an embodiment, the dynamic tracing virtual machine is a processing unit 516 as shown in FIG. 5, that executes a preserving dynamic trace purity script or computer software application that carries out the operations of at least method 100. In an embodiment, the dynamic tracing virtual machine is a computer system 500 as shown in FIG. 5, that executes a preserving dynamic trace purity script or computer software application that carries out at least operation 112. In an embodiment, the dynamic tracing virtual machine is a computer system/server 512 as shown in FIG. 5, that executes a preserving dynamic trace purity script or computer software application that carries out at least operation 112. In an embodiment, the dynamic tracing virtual machine is a processing unit 516 as shown in FIG. 5, that executes a preserving dynamic trace purity script or computer software application that carries out at least operation 112. In an embodiment, the dynamic tracing virtual machine is a script or computer software application, executing on the host computer system, that executes a preserving dynamic trace purity script or computer software application that carries out at least operation 112.

In an embodiment, the trace consumer accelerator computer system is a computer system 500 as shown in FIG. 5, that executes a preserving dynamic trace purity script or computer software application that carries out the operations of at least method 100. In an embodiment, the trace consumer accelerator computer system is a computer system/server 512 as shown in FIG. 5, that executes a preserving dynamic trace purity script or computer software application that carries out the operations of at least method 100. In an embodiment, the trace consumer accelerator computer system is a processing unit 516 as shown in FIG. 5, that executes a preserving dynamic trace purity script or computer software application that carries out the operations of at least method 100. In an embodiment, the trace consumer accelerator computer system is a computer system 500 as shown in FIG. 5, that executes a preserving dynamic trace purity script or computer software application that carries out at least operations 120, 122, 124, 126, and 128. In an embodiment, the trace consumer accelerator computer system is a computer system/server 512 as shown in FIG. 5, that executes a preserving dynamic trace purity script or computer software application that carries out at least operations 120, 122, 124, 126, and 128. In an embodiment, the trace consumer accelerator computer system is a processing unit 516 as shown in FIG. 5, that executes a preserving dynamic trace purity script or computer software application that carries out at least operations 120, 122, 124, 126, and 128.

Referring to FIG. 1C, in an exemplary embodiment, the present invention includes a host computer system 130, a dynamic tracing virtual machine 132, a trace consumer accelerator computer system 134, predefined computer storage buffers 136, a common device computer storage buffer 138, and a computer display 139. In a particular embodiment, trace consumer accelerator computer system 134 includes a coherent accelerator processor interface (CAPI) device. In a specific embodiment, trace consumer accelerator computer system 134 is a CAPI device. In a particular embodiment, predefined computer storage buffers 136 include portions of computer memory within host computer system 130, where the portions have predefined computer memory addresses. In a specific embodiment, predefined computer storage buffers 136 are portions of computer memory within host computer system 130, where the portions have predefined computer memory addresses.

In an embodiment, host computer system 130 is configured to compile a dynamic tracing computer software script 140 into a computer software format, where the computer software format is understandable by dynamic tracing virtual machine 132 executing on host computer system 130 and understandable by trace consumer accelerator computer system 134 logically coupled to host computer system 130, resulting in a compiled dynamic tracing computer script 142. In an embodiment, host computer system 130 includes a computer system, such as computer system 500 as shown in FIG. 5, performing operation 110. In an embodiment, host computer system 130 includes a computer system, such as computer system/server 512 as shown in FIG. 5, performing operation 110. In an embodiment, host computer system 130 includes a computer system, such as processing unit 516 as shown in FIG. 5, performing operation 110. In an embodiment, host computer system 130 is implemented as computer software executing on a computer system, such as computer system 500 as shown in FIG. 5, such that the computer system performs operation 110. In an embodiment, host computer system 130 is implemented as computer software executing on a computer system, such as computer system/server 512 as shown in FIG. 5, such that the computer system performs operation 110. In an embodiment, host computer system 130 is implemented as computer software executing on a computer system, such as processing unit 516 as shown in FIG. 5, such that the computer system performs operation 110.

In an embodiment, dynamic tracing virtual machine 132 is configured to execute a set of logical operations, represented by compiled dynamic tracing computer software script 142, tracing an execution 144 of a host computer software program executing on host computer system 130, resulting in trace data. In an embodiment, dynamic tracing virtual machine 132 includes a computer system, such as computer system 500 as shown in FIG. 5, performing operation 112. In an embodiment, dynamic tracing virtual machine 132 includes a computer system, such as computer system/server 512 as shown in FIG. 5, performing operation 112. In an embodiment, dynamic tracing virtual machine 132 includes a computer system, such as processing unit 516 as shown in FIG. 5, performing operation 112. In an embodiment, dynamic tracing virtual machine 132 is implemented as computer software executing on a computer system, such as computer system 500 as shown in FIG. 5, such that the computer system performs operation 112. In an embodiment, dynamic tracing virtual machine 132 is implemented as computer software executing on a computer system, such as computer system/server 512 as shown in FIG. 5, such that the computer system performs operation 112. In an embodiment, dynamic tracing virtual machine 132 is implemented as computer software executing on a computer system, such as processing unit 516 as shown in FIG. 5, such that the computer system performs operation 112.

In a particular embodiment, dynamic tracing virtual machine 132 includes a kernel tracing virtual machine, where the kernel tracing virtual machine is resident within a kernel of an operating system executing on host computer system 130. In a specific embodiment, dynamic tracing virtual machine 132 is a kernel tracing virtual machine, where the kernel tracing virtual machine is resident within a kernel of an operating system executing on host computer system 130. In a particular embodiment, dynamic tracing virtual machine 132 includes a user space tracing virtual machine, where the user space virtual machine is resident within a user space executing on host computer system 130. In a specific embodiment, dynamic tracing virtual machine 132 is a user space tracing virtual machine, where the user space virtual machine is resident within a user space executing on host computer system 130.

In an embodiment, host computer system 130 is configured to activate points in the executing of compiled dynamic tracing computer software script 142 (probe points) at which the trace data can be collected. In an embodiment, host computer system 130 includes a computer system, such as computer system 500 as shown in FIG. 5, performing operation 114. In an embodiment, host computer system 130 includes a computer system, such as computer system/server 512 as shown in FIG. 5, performing operation 114. In an embodiment, host computer system 130 includes a computer system, such as processing unit 516 as shown in FIG. 5, performing operation 114. In an embodiment, host computer system 130 is implemented as computer software executing on a computer system, such as computer system 500 as shown in FIG. 5, such that the computer system performs operation 114. In an embodiment, host computer system 130 is implemented as computer software executing on a computer system, such as computer system/server 512 as shown in FIG. 5, such that the computer system performs operation 114. In an embodiment, host computer system 130 is implemented as computer software executing on a computer system, such as processing unit 516 as shown in FIG. 5, such that the computer system performs operation 114.

In an embodiment, host computer system 130 is configured to collect the trace data from the probe points. In an embodiment, host computer system 130 includes a computer system, such as computer system 500 as shown in FIG. 5, performing operation 116. In an embodiment, host computer system 130 includes a computer system, such as computer system/server 512 as shown in FIG. 5, performing operation 116. In an embodiment, host computer system 130 includes a computer system, such as processing unit 516 as shown in FIG. 5, performing operation 116. In an embodiment, host computer system 130 is implemented as computer software executing on a computer system, such as computer system 500 as shown in FIG. 5, such that the computer system performs operation 116. In an embodiment, host computer system 130 is implemented as computer software executing on a computer system, such as computer system/server 512 as shown in FIG. 5, such that the computer system performs operation 116. In an embodiment, host computer system 130 is implemented as computer software executing on a computer system, such as processing unit 516 as shown in FIG. 5, such that the computer system performs operation 116.

In an embodiment, host computer system 130 is configured to store the collected trace data in predefined computer storage buffers 136 within host computer system 130, where predefined computer storage buffers 136 are addressable by central processing units (CPUs) of host computer system 130 and are addressable by trace consumer accelerator computer system 134. In an embodiment, host computer system 130 includes a computer system, such as computer system 500 as shown in FIG. 5, performing operation 118. In an embodiment, host computer system 130 includes a computer system, such as computer system/server 512 as shown in FIG. 5, performing operation 118. In an embodiment, host computer system 130 includes a computer system, such as processing unit 516 as shown in FIG. 5, performing operation 118. In an embodiment, host computer system 130 is implemented as computer software executing on a computer system, such as computer system 500 as shown in FIG. 5, such that the computer system performs operation 118. In an embodiment, host computer system 130 is implemented as computer software executing on a computer system, such as computer system/server 512 as shown in FIG. 5, such that the computer system performs operation 118. In an embodiment, host computer system 130 is implemented as computer software executing on a computer system, such as processing unit 516 as shown in FIG. 5, such that the computer system performs operation 118.

In an embodiment, trace consumer accelerator computer system 134 is configured to collect the stored trace data from predefined computer storage buffers 136 on a periodic basis, resulting in periodically collected trace data. In an embodiment, trace consumer accelerator computer system 134 includes a computer system, such as computer system 500 as shown in FIG. 5, performing operation 120. In an embodiment, trace consumer accelerator computer system 134 includes a computer system, such as computer system/server 512 as shown in FIG. 5, performing operation 120. In an embodiment, trace consumer accelerator computer system 134 includes a computer system, such as processing unit 516 as shown in FIG. 5, performing operation 120. In an embodiment, trace consumer accelerator computer system 134 is implemented as computer software executing on a computer system, such as computer system 500 as shown in FIG. 5, such that the computer system performs operation 120. In an embodiment, trace consumer accelerator computer system 134 is implemented as computer software executing on a computer system, such as computer system/server 512 as shown in FIG. 5, such that the computer system performs operation 120. In an embodiment, trace consumer accelerator computer system 134 is implemented as computer software executing on a computer system, such as processing unit 516 as shown in FIG. 5, such that the computer system performs operation 120.

In an embodiment, trace consumer accelerator computer system 134 is configured to store the periodically collected trace data in common device computer storage buffer 138. In an embodiment, trace consumer accelerator computer system 134 includes a computer system, such as computer system 500 as shown in FIG. 5, performing operation 122. In an embodiment, trace consumer accelerator computer system 134 includes a computer system, such as computer system/server 512 as shown in FIG. 5, performing operation 122. In an embodiment, trace consumer accelerator computer system 134 includes a computer system, such as processing unit 516 as shown in FIG. 5, performing operation 122. In an embodiment, trace consumer accelerator computer system 134 is implemented as computer software executing on a computer system, such as computer system 500 as shown in FIG. 5, such that the computer system performs operation 122. In an embodiment, trace consumer accelerator computer system 134 is implemented as computer software executing on a computer system, such as computer system/server 512 as shown in FIG. 5, such that the computer system performs operation 122. In an embodiment, trace consumer accelerator computer system 134 is implemented as computer software executing on a computer system, such as processing unit 516 as shown in FIG. 5, such that the computer system performs operation 122.

In an embodiment, trace consumer accelerator computer system 134 is configured to sort the stored periodically collected trace data by the order of times at which the stored periodically collected trace data was generated by the executing of compiled dynamic tracing computer software script 142, resulting in sorted trace data. In an embodiment, trace consumer accelerator computer system 134 includes a computer system, such as computer system 500 as shown in FIG. 5, performing operation 124. In an embodiment, trace consumer accelerator computer system 134 includes a computer system, such as computer system/server 512 as shown in FIG. 5, performing operation 124. In an embodiment, trace consumer accelerator computer system 134 includes a computer system, such as processing unit 516 as shown in FIG. 5, performing operation 124. In an embodiment, trace consumer accelerator computer system 134 is implemented as computer software executing on a computer system, such as computer system 500 as shown in FIG. 5, such that the computer system performs operation 124. In an embodiment, trace consumer accelerator computer system 134 is implemented as computer software executing on a computer system, such as computer system/server 512 as shown in FIG. 5, such that the computer system performs operation 124. In an embodiment, trace consumer accelerator computer system 134 is implemented as computer software executing on a computer system, such as processing unit 516 as shown in FIG. 5, such that the computer system performs operation 124.

In an embodiment, trace consumer accelerator computer system 134 is configured to convert raw address data within the sorted trace data into trace display data. In an embodiment, trace consumer accelerator computer system 134 includes a computer system, such as computer system 500 as shown in FIG. 5, performing operation 126. In an embodiment, trace consumer accelerator computer system 134 includes a computer system, such as computer system/server 512 as shown in FIG. 5, performing operation 126. In an embodiment, trace consumer accelerator computer system 134 includes a computer system, such as processing unit 516 as shown in FIG. 5, performing operation 126. In an embodiment, trace consumer accelerator computer system 134 is implemented as computer software executing on a computer system, such as computer system 500 as shown in FIG. 5, such that the computer system performs operation 126. In an embodiment, trace consumer accelerator computer system 134 is implemented as computer software executing on a computer system, such as computer system/server 512 as shown in FIG. 5, such that the computer system performs operation 126. In an embodiment, trace consumer accelerator computer system 134 is implemented as computer software executing on a computer system, such as processing unit 516 as shown in FIG. 5, such that the computer system performs operation 126.

In an embodiment, trace consumer accelerator computer system 134 is configured to display the trace display data on computer display 139. In an embodiment, trace consumer accelerator computer system 134 includes a computer system, such as computer system 500 as shown in FIG. 5, performing operation 128. In an embodiment, trace consumer accelerator computer system 134 includes a computer system, such as computer system/server 512 as shown in FIG. 5, performing operation 128. In an embodiment, trace consumer accelerator computer system 134 includes a computer system, such as processing unit 516 as shown in FIG. 5, performing operation 128. In an embodiment, trace consumer accelerator computer system 134 is implemented as computer software executing on a computer system, such as computer system 500 as shown in FIG. 5, such that the computer system performs operation 128. In an embodiment, trace consumer accelerator computer system 134 is implemented as computer software executing on a computer system, such as computer system/server 512 as shown in FIG. 5, such that the computer system performs operation 128. In an embodiment, trace consumer accelerator computer system 134 is implemented as computer software executing on a computer system, such as processing unit 516 as shown in FIG. 5, such that the computer system performs operation 128. In an embodiment, trace consumer accelerator computer system 134 includes computer display 139.

### Analyzing the Trace Data

In a further embodiment, the computer implemented method, the system, and the computer program product further include executing, by the trace consumer accelerator computer system, a set of logical operations, represented by the compiled dynamic tracing computer software script, analyzing the trace data. In an embodiment, trace consumer accelerator computer system 134 is configured to execute a set of logical operations, represented by compiled dynamic tracing computer software script 142, analyzing the trace data. In an embodiment, trace consumer accelerator computer system 134 includes a computer system, such as computer system 500 as shown in FIG. 5, executing a set of logical operations, represented by compiled dynamic tracing computer software script 142, analyzing the trace data. In an embodiment, trace consumer accelerator computer system 134 includes a computer system, such as computer system/server 512 as shown in FIG. 5, executing a set of logical operations, represented by compiled dynamic tracing computer software script 142, analyzing the trace data. In an embodiment, trace consumer accelerator computer system 134 includes a computer system, such as processing unit 516 as shown in FIG. 5, executing a set of logical operations, represented by compiled dynamic tracing computer software script 142, analyzing the trace data.

In an embodiment, trace consumer accelerator computer system 134 is implemented as computer software executing on a computer system, such as computer system 500 as shown in FIG. 5, such that the computer system executes a set of logical operations, represented by compiled dynamic tracing computer software script 142, analyzing the trace data. In an embodiment, trace consumer accelerator computer system 134 is implemented as computer software executing on a computer system, such as computer system/server 512 as shown in FIG. 5, such that the computer system executes a set of logical operations, represented by compiled dynamic tracing computer software script 142, analyzing the trace data. In an embodiment, trace consumer accelerator computer system 134 is implemented as computer software executing on a computer system, such as processing unit 516 as shown in FIG. 5, such that the computer system executes a set of logical operations, represented by compiled dynamic tracing computer software script 142, analyzing the trace data. In an embodiment, trace consumer accelerator computer system 134 executes a set of logical operations, represented by compiled dynamic tracing computer software script 142, analyzing the trace data as computer software executing on a processor of trace consumer accelerator computer system 134.

In a particular embodiment, the analyzing includes executing a set of logical operations updating dynamic data structures. In an embodiment, trace consumer accelerator computer system 134 is configured to execute a set of logical operations updating dynamic data structures. In an embodiment, trace consumer accelerator computer system 134 includes a computer system, such as computer system 500 as shown in FIG. 5, executing a set of logical operations updating dynamic data structures. In an embodiment, trace consumer accelerator computer system 134 includes a computer system, such as computer system/server 512 as shown in FIG. 5, executing a set of logical operations updating dynamic data structures. In an embodiment, trace consumer accelerator computer system 134 includes a computer system, such as processing unit 516 as shown in FIG. 5, executing a set of logical operations updating dynamic data structures.

In an embodiment, trace consumer accelerator computer system 134 is implemented as computer software executing on a computer system, such as computer system 500 as shown in FIG. 5, such that the computer system executes a set of logical operations updating dynamic data structures. In an embodiment, trace consumer accelerator computer system 134 is implemented as computer software executing on a computer system, such as computer system/server 512 as shown in FIG. 5, such that the computer system executes a set of logical operations updating dynamic data structures. In an embodiment, trace consumer accelerator computer system 134 is implemented as computer software executing on a computer system, such as processing unit 516 as shown in FIG. 5, such that the computer system executes a set of logical operations updating dynamic data structures. In an embodiment, trace consumer accelerator computer system 134 executes a set of logical operations updating dynamic data structures as computer software executing on a processor of trace consumer accelerator computer system 134. In a particular embodiment, the dynamic data structures include associative arrays. In a specific embodiment, the dynamic data structures are associative arrays. In an embodiment, the dynamic data structures are associated with host computer system 130. In an embodiment, the dynamic data structures are associated with dynamic tracing virtual machine 132. In an embodiment, the dynamic data structures are associated with trace consumer accelerator computer system 134.

### Activating Probe Points

In an exemplary embodiment, the activating includes activating, by the dynamic tracing virtual machine, the probe points at which the trace data can be collected. In an embodiment, activating operation 114 includes activating, by the dynamic tracing virtual machine, the probe points at which the trace data can be collected. In an embodiment, the dynamic tracing virtual machine 132 is configured to activate the probe points at which the trace data can be collected. In an embodiment, dynamic tracing virtual machine 132 includes a computer system, such as computer system 500 as shown in FIG. 5, activating the probe points at which the trace data can be collected. In an embodiment, dynamic tracing virtual machine 132 includes a computer system, such as computer system/server 512 as shown in FIG. 5, activating the probe points at which the trace data can be collected. In an embodiment, dynamic tracing virtual machine 132 includes a computer system, such as processing unit 516 as shown in FIG. 5, activating the probe points at which the trace data can be collected.

In an embodiment, dynamic tracing virtual machine 132 is implemented as computer software executing on a computer system, such as computer system 500 as shown in FIG. 5, such that the computer system activates the probe points at which the trace data can be collected. In an embodiment, dynamic tracing virtual machine 132 is implemented as computer software executing on a computer system, such as computer system/server 512 as shown in FIG. 5, such that the computer system activates the probe points at which the trace data can be collected. In an embodiment, dynamic tracing virtual machine 132 is implemented as computer software executing on a computer system, such as processing unit 516 as shown in FIG. 5, such that the computer system activates the probe points at which the trace data can be collected. In an embodiment, dynamic tracing virtual machine 132 activates the probe points at which the trace data can be collected as computer software executing on a processor of host computer system 130.

### Storing the Periodically Collected Trace Data

In an exemplary embodiment, the storing the periodically collected trace data in the common device computer storage buffer includes collating the periodically collected trace data in the common device computer storage buffer. In an embodiment, storing the periodically collected trace data in a common device computer storage buffer operation 122 includes collating the periodically collected trace data in the common device computer storage buffer. In an embodiment, trace consumer accelerator computer system 134 is configured to collate the periodically collected trace data in common device computer storage buffer 138. In an embodiment, trace consumer accelerator computer system 134 includes a computer system, such as computer system 500 as shown in FIG. 5, collating the periodically collected trace data in common device computer storage buffer 138. In an embodiment, trace consumer accelerator computer system 134 includes a computer system, such as computer system/server 512 as shown in FIG. 5, collating the periodically collected trace data in common device computer storage buffer 138. In an embodiment, trace consumer accelerator computer system 134 includes a computer system, such as processing unit 516 as shown in FIG. 5, collating the periodically collected trace data in common device computer storage buffer 138.

In an embodiment, trace consumer accelerator computer system 134 is implemented as computer software executing on a computer system, such as computer system 500 as shown in FIG. 5, such that the computer system collates the periodically collected trace data in common device computer storage buffer 138. In an embodiment, trace consumer accelerator computer system 134 is implemented as computer software executing on a computer system, such as computer system/server 512 as shown in FIG. 5, such that the computer system collates the periodically collected trace data in common device computer storage buffer 138. In an embodiment, trace consumer accelerator computer system 134 is implemented as computer software executing on a computer system, such as processing unit 516 as shown in FIG. 5, such that the computer system collates the periodically collected trace data in common device computer storage buffer 138. In an embodiment, trace consumer accelerator computer system 134 collates the periodically collected trace data in common device computer storage buffer 138 as computer software executing on a processor of trace consumer accelerator computer system 134.

### Sorting the Stored Periodically Collected Trace Data

In an exemplary embodiment, the sorting the stored periodically collected trace data includes executing a set of logical operations performing a sorting algorithm that can be executed by a computer system including multiple processors. In an embodiment, sorting the stored periodically collected trace data operation 124 includes executing a set of logical operations performing a sorting algorithm that can be executed by a computer system including multiple processors. In an embodiment, trace consumer accelerator computer system 134 is configured to execute a set of logical operations performing a sorting algorithm that can be executed by a computer system including multiple processors. In an embodiment, trace consumer accelerator computer system 134 includes a computer system, such as computer system 500 as shown in FIG. 5, executing a set of logical operations performing a sorting algorithm that can be executed by a computer system including multiple processors. In an embodiment, trace consumer accelerator computer system 134 includes a computer system, such as computer system/server 512 as shown in FIG. 5, executing a set of logical operations performing a sorting algorithm that can be executed by a computer system including multiple processors. In an embodiment, trace consumer accelerator computer system 134 includes a computer system, such as processing unit 516 as shown in FIG. 5, executing a set of logical operations performing a sorting algorithm that can be executed by a computer system including multiple processors.

In an embodiment, trace consumer accelerator computer system 134 is implemented as computer software executing on a computer system, such as computer system 500 as shown in FIG. 5, such that the computer system executes a set of logical operations performing a sorting algorithm that can be executed by a computer system including multiple processors. In an embodiment, trace consumer accelerator computer system 134 is implemented as computer software executing on a computer system, such as computer system/server 512 as shown in FIG. 5, such that the computer system executes a set of logical operations performing a sorting algorithm that can be executed by a computer system including multiple processors. In an embodiment, trace consumer accelerator computer system 134 is implemented as computer software executing on a computer system, such as processing unit 516 as shown in FIG. 5, such that the computer system executes a set of logical operations performing a sorting algorithm that can be executed by a computer system including multiple processors. In an embodiment, trace consumer accelerator computer system 134 executes a set of logical operations performing a sorting algorithm that can be executed by a computer system including multiple processors as computer software executing on a processor of trace consumer accelerator computer system 134. In a particular embodiment, the sorting algorithm includes a bitonic sort algorithm. In a specific embodiment, the sorting algorithm is a bitonic sort algorithm.

Converting Raw Address Data into Trace Display Data

In an exemplary embodiment, the trace display data includes at least one of data describing symbols and data describing at least one graph. In a particular embodiment, converting operation 126 includes converting the raw address data within the sorted trace data into the data describing the symbols via a pre-cached symbol table associated with the host computer software program and associated with a kernel of an operating system executing on the host computer system. In an embodiment, trace consumer accelerator computer system 134 is configured to convert the raw address data within the sorted trace data into the data describing the symbols via a pre-cached symbol table associated with the host computer software program and associated with a kernel of an operating system executing on host computer system 130. In an embodiment, trace consumer accelerator computer system 134 includes a computer system, such as computer system 500 as shown in FIG. 5, converting the raw address data within the sorted trace data into the data describing the symbols via a pre-cached symbol table associated with the host computer software program and associated with a kernel of an operating system executing on host computer system 130. In an embodiment, trace consumer accelerator computer system 134 includes a computer system, such as computer system/server 512 as shown in FIG. 5, converting the raw address data within the sorted trace data into the data describing the symbols via a pre-cached symbol table associated with the host computer software program and associated with a kernel of an operating system executing on host computer system 130. In an embodiment, trace consumer accelerator computer system 134 includes a computer system, such as processing unit 516 as shown in FIG. 5, converting the raw address data within the sorted trace data into the data describing the symbols via a pre-cached symbol table associated with the host computer software program and associated with a kernel of an operating system executing on host computer system 130.

In an embodiment, trace consumer accelerator computer system 134 is implemented as computer software executing on a computer system, such as computer system 500 as shown in FIG. 5, such that the computer system converts the raw address data within the sorted trace data into the data describing the symbols via a pre-cached symbol table associated with the host computer software program and associated with a kernel of an operating system executing on host computer system 130. In an embodiment, trace consumer accelerator computer system 134 is implemented as computer software executing on a computer system, such as computer system/server 512 as shown in FIG. 5, such that the computer system converts the raw address data within the sorted trace data into the data describing the symbols via a pre-cached symbol table associated with the host computer software program and associated with a kernel of an operating system executing on host computer system 130. In an embodiment, trace consumer accelerator computer system 134 is implemented as computer software executing on a computer system, such as processing unit 516 as shown in FIG. 5, such that the computer system converts the raw address data within the sorted trace data into the data describing the symbols via a pre-cached symbol table associated with the host computer software program and associated with a kernel of an operating system executing on host computer system 130. In an embodiment, trace consumer accelerator computer system 134 converts the raw address data within the sorted trace data into the data describing the symbols via a pre-cached symbol table associated with the host computer software program and associated with a kernel of an operating system executing on host computer system 130 as computer software executing on a processor of trace consumer accelerator computer system 134.

### Storing the Trace Display Data

In a further embodiment, the computer implemented method, the system, and the computer program product further include storing, by the trace consumer accelerator computer system, the trace display data in a computer storage device logically coupled to the trace consumer accelerator computer system. In an embodiment, trace consumer accelerator computer system 134 is configured to store the trace display data in a computer storage device logically coupled to trace consumer accelerator computer system 134. In an embodiment, trace consumer accelerator computer system 134 includes a computer system, such as computer system 500 as shown in FIG. 5, storing the trace display data in a computer storage device logically coupled to trace consumer accelerator computer system 134. In an embodiment, trace consumer accelerator computer system 134 includes a computer system, such as computer system/server 512 as shown in FIG. 5, storing the trace display data in a computer storage device logically coupled to trace consumer accelerator computer system 134. In an embodiment, trace consumer accelerator computer system 134 includes a computer system, such as processing unit 516 as shown in FIG. 5, storing the trace display data in a computer storage device logically coupled to trace consumer accelerator computer system 134.

In an embodiment, trace consumer accelerator computer system 134 is implemented as computer software executing on a computer system, such as computer system 500 as shown in FIG. 5, such that the computer system stores the trace display data in a computer storage device logically coupled to trace consumer accelerator computer system 134. In an embodiment, trace consumer accelerator computer system 134 is implemented as computer software executing on a computer system, such as computer system/server 512 as shown in FIG. 5, such that the computer system stores the trace display data in a computer storage device logically coupled to trace consumer accelerator computer system 134. In an embodiment, trace consumer accelerator computer system 134 is implemented as computer software executing on a computer system, such as processing unit 516 as shown in FIG. 5, such that the computer system stores the trace display data in a computer storage device logically coupled to trace consumer accelerator computer system 134. In an embodiment, trace consumer accelerator computer system 134 stores the trace display data in a computer storage device logically coupled to trace consumer accelerator computer system 134 as computer software executing on a processor of trace consumer accelerator computer system 134. In a particular embodiment, the computer storage device includes at least one of a computer network storage device and a solid-state drive (SSD) computer storage device. In a specific embodiment, the computer storage device is at least one of a computer network storage device and a solid-state drive (SSD) computer storage device.

### Trace Generation, Collection, and Processing

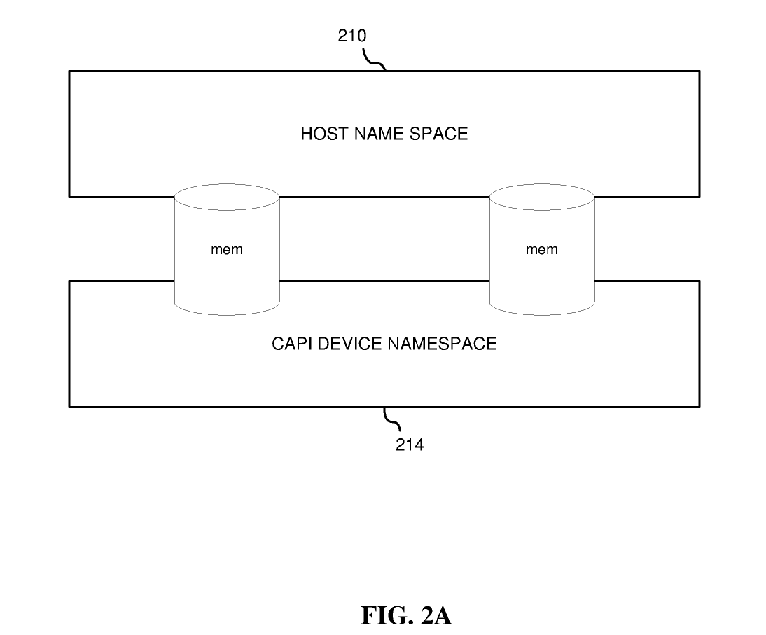

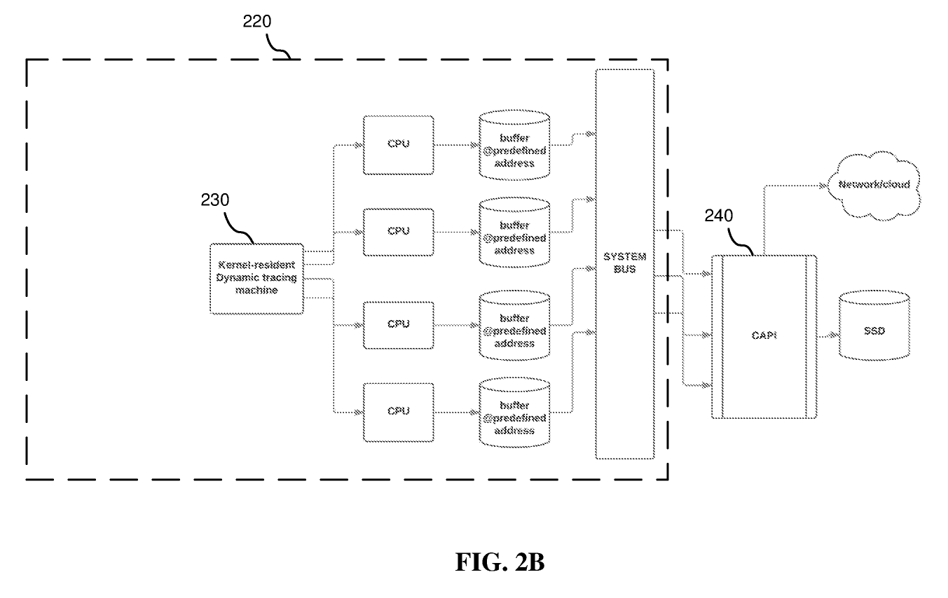

In an embodiment, the present invention performs tracing tasks via different layers, as depicted in FIG. 2A. For example, the present invention could perform trace generation in a host namespace 210 of host computer system 130. Also, the present invention could perform trace collection, trace compression, and trace presentation in a CAPI device namespace 214 of a CAPI device/trace consumer accelerator computer system 134.

In an embodiment, the present invention performs trace buffer handling via the system depicted in FIG. 2B. In an embodiment, the present invention executes the operations of method 100 via the system depicted in FIG. 2B. In an embodiment, the operations in method 100 are executed via multiple computing threads on the CAPI device/trace consumer accelerator computer system 134 via the system depicted in FIG. 2B. For example, host computer system 130 could be a computer system 220. Also, for example, dynamic tracing virtual machine 132 could be kernel-resident dynamic tracing machine 230. In addition, for example, trace consumer accelerator computer system 134 could be a CAPI 240.

### EXAMPLE

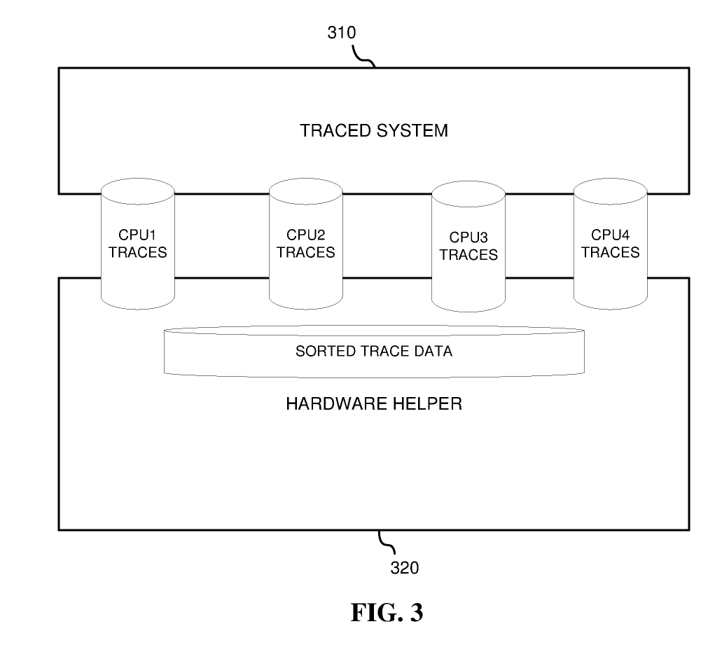

Referring to FIG. 3, for example, the present invention could perform dynamic tracing of a traced system 310, such as host computer system 130, and trace data processing using an accelerator or a hardware helper 320, such as trace consumer accelerator computer system 134. Dynamic tracing consists of two distinct phases, trace generation and trace collection/distribution. For example, the present invention could carry out the collection of traces by an accelerated device (e.g., CAPI device)/hardware helper 320, such as trace consumer accelerator computer system 134, at pre-agreed addresses. For example, hardware helper 320, such as trace consumer accelerator 134, could process the trace data and could feed the trace data to a user. For example, since the trace data could come from multiple processors, hardware helper 320, such as trace consumer accelerator 134, could sort the trace data from common device computer storage buffer 138 by the order of generation of the trace data. Specifically, for example, hardware helper 320, such as trace consumer accelerator 134, could aggregate the incoming trace elements/trace data in a common buffer, such as common device computer storage buffer 138, and could sort incoming trace elements/trace data by comparing timestamps of such incoming trace elements/trace data at their generation.

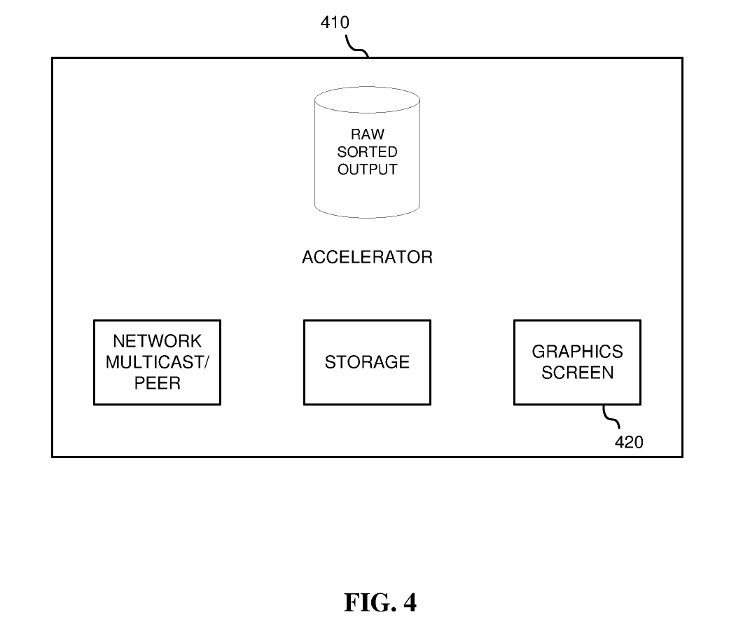

Subsequently, as depicted in FIG. 4, for example, an accelerator 410, such as hardware helper 320 and such as trace consumer accelerator 134, could feed the trace stream generated in the common buffer, such as common device computer storage buffer 138, into a consumer manager engine, that resides in the accelerator, such as hardware helper 320 and such as trace consumer accelerator 134, and that manages storage/display of trace messages. In a specific example, the consumer manager engine could stream/store the trace data to a single entity or multicast the trace to different consumers. For example, computer display 139 could be a graphics screen 420 logically coupled to accelerator 410.

### Computer System

In an exemplary embodiment, the computer system is a computer system 500 as shown in FIG. 5. Computer system 500 is only one example of a computer system and is not intended to suggest any limitation as to the scope of use or functionality of embodiments of the present invention. Regardless, computer system 500 is capable of being implemented to perform and/or performing any of the functionality/operations of the present invention.

Computer system 500 includes a computer system/server 512, which is operational with numerous other general purpose or special purpose computing system environments or configurations. Examples of well-known computing systems, environments, and/or configurations that may be suitable for use with computer system/server 512 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer system/server 512 may be described in the general context of computer system-executable instructions, such as program modules, being executed by a computer system. Generally, program modules may include routines, programs, objects, components, logic, and/or data structures that perform particular tasks or implement particular abstract data types. Computer system/server 512 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 512 in computer system 500 is shown in the form of a general-purpose computing device. The components of computer system/server 512 may include, but are not limited to, one or more processors or processing units 516, a system memory 528, and a bus 518 that couples various system components including system memory 528 to processor 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 512 typically includes a variety of computer system readable media. Such media may be any available media that is accessible by computer system/server 512, and includes both volatile and non-volatile media, removable and non-removable media.

System memory 528 can include computer system readable media in the form of volatile memory, such as random access memory (RAM) 530 and/or cache memory 532. Computer system/server 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions/operations of embodiments of the invention.

Program/utility 540, having a set (at least one) of program modules 542, may be stored in memory 528 by way of example, and not limitation. Exemplary program modules 542 may include an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the present invention.

Computer system/server 512 may also communicate with one or more external devices 514 such as a keyboard, a pointing device, a display 524, one or more devices that enable a user to interact with computer system/server 512, and/or any devices (e.g., network card, modem, etc.) that enable computer system/server 512 to communicate with one or more other computing devices. Such communication can occur via Input/Output (I/O) interfaces 522. Still yet, computer system/server 512 can communicate with one or more networks such as a local area network (LAN), a general wide area network (WAN), and/or a public network (e.g., the Internet) via network adapter 520. As depicted, network adapter 520 communicates with the other components of computer system/server 512 via bus 518. It should be understood that although not shown, other hardware and/or software components could be used in conjunction with computer system/server 512. Examples, include, but are not limited to: microcode, device drivers, redundant processing units, external disk drive arrays, RAID systems, tape drives, and data archival storage systems.

### Computer Program Product

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer implemented method comprising:
compiling, by a host computer system, a dynamic tracing computer software script into a computer software format, wherein the computer software format is understandable by a dynamic tracing virtual machine executing on the host computer system and understandable by a trace consumer accelerator computer system logically coupled to the host computer system, resulting in a compiled dynamic tracing computer script;
executing, by the dynamic tracing virtual machine, a set of logical operations, represented by the compiled dynamic tracing computer software script, tracing an execution of a host computer software program executing on the host computer system, resulting in trace data;
activating, by the host computer system, points in the executing of the compiled dynamic tracing computer software script (probe points) at which the trace data can be collected,
wherein the activating comprises activating, by the dynamic tracing virtual machine, the probe points at which the trace data can be collected;
collecting, by the host computer system, the trace data from the probe points;
storing, by the host computer system, the collected trace data in predefined computer storage buffers within the host computer system, wherein the predefined computer storage buffers are addressable by central processing units (CPUs) of the host computer system and are addressable by the trace consumer accelerator computer system;
collecting, by the trace consumer accelerator computer system, the stored trace data from the predefined computer storage buffers on a periodic basis, resulting in periodically collected trace data;
storing, by the trace consumer accelerator computer system, the periodically collected trace data in a common device computer storage buffer,
wherein the storing the periodically collected trace data in the common device computer storage buffer comprises collating the periodically collected trace data in the common device computer storage buffer;
sorting, by the trace consumer accelerator computer system, the stored periodically collected trace data by the order of times at which the stored periodically collected trace data was generated by the executing of the compiled dynamic tracing computer software script, resulting in sorted trace data,
wherein the sorting the stored periodically collected trace data comprises executing a set of logical operations performing a sorting algorithm that can be executed by a computer system comprising multiple processors;
converting, by the trace consumer accelerator computer system, raw address data within the sorted trace data into trace display data,
wherein the converting comprises converting, the raw address data within the sorted trace data into the data describing the symbols via a pre-cached symbol table associated with the host computer software program and associated with a kernel of an operating system executing on the host computer system;
displaying, by the trace consumer accelerator computer system, the trace display data on a computer display;
executing, by the trace consumer accelerator computer system, a set of logical operations, represented by the compiled dynamic tracing computer software script, analyzing the trace data,
wherein the analyzing comprises executing a set of logical operations updating dynamic data structures; and
wherein the trace consumer accelerator computer system comprises a coherent accelerator processor interface (CAPI) device, the trace display data on a computer display.
